(19) United States
(12) Patent Application Publication
(10) Pub. No.: US 2010/0051711 A1
(43) Pub. Date: Mar. 4, 2010

(54) REVERSIBLE COOLING FAN FOR VEHICLE AND METHOD FOR CONTROLLING DIRECTION OF ROTATION

(75) Inventor: Sean Cavanaugh, Farmington Hills, MI (US)

Correspondence Address: YOUNG BASILE, 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 12/201,286

(22) Filed: Aug. 29, 2008

(51) Int. Cl. B60H 1/02; F28D 15/00

(52) U.S. Cl. 237/12.3 A; 165/104.34

(57) ABSTRACT

An apparatus for heating a passenger compartment of a vehicle having an engine room defining a ram airflow path, an engine located in the engine room, and a cooling pack located in the ram airflow path for dissipating waste heat generated by the engine is described. The apparatus includes a fan positioned in the ram airflow path, the fan responsive to a control signal to operate in at least two modes relative to the ram airflow path. The apparatus also includes a controller responsive to at least one sensor and configured to generate the control signal to operate the fan in a first mode when the detected one or more operating conditions are in a first state and to operate the fan in a second mode when the detected one or more operating conditions are in a second state.

### FIELD OF THE INVENTION

The present invention pertains to the field of heating a passenger compartment in a vehicle, and more particularly to controlling a fan providing airflow to a heat exchanger.

### BACKGROUND

Internal combustion engines in vehicles produce heat during operation. A heat exchanging system can be provided to ensure the engine is kept below a certain temperature. For example, a heat exchanging system can include a radiator to dissipate heat produced by the engine and a condenser to dissipate heat produced by an air conditioning system. Forced convection is often used to transfer heat away from the radiator and condenser using airflow provided by at least one of an electric fan, an engine-driven fan, and ram airflow resulting from the movement of the vehicle.

Under certain circumstances, for example, when an ambient air temperature outside the vehicle is cold, it is desirable to dissipate less heat than the heat exchanging system is designed to dissipate. A heat exchanging system for a diesel engine is particularly susceptible to dissipating more heat than desirable when the ambient air temperature is cold and ram airflow is high (e.g., when the vehicle is travelling fast) because diesel engines generally do not produce as much heat as gasoline engines. In response, a driver of diesel engine truck will often place a grille cover, such as a fabric or plastic sheet, over at least a portion of the grille of his vehicle during the winter in order to reduce the ram airflow passing over the heat exchanging system.

### SUMMARY

In one disclosed embodiment, an apparatus for heating a passenger compartment of a vehicle having an engine room defining a rain airflow path, an engine located in the engine room, and a cooling pack located in the ram airflow path for dissipating waste heat generated by the engine is provided. The apparatus includes a heater configured to provide heated air to the passenger compartment. The heater is in thermal communication with the engine to transfer waste heat from the engine to the passenger compartment. A sensor is configured to detect one or more operating conditions of the vehicle. A fan is positioned in the ram airflow path, and the fan is responsive to a control signal to operate in at least two modes relative to the ram airflow path. A controller is responsive to the sensor and configured to generate the control signal to operate the fan in a first mode when the detected one or more operating conditions are in a first state and to operate the fan in a second mode when the detected one or more operating conditions are in a second state.

In another embodiment, an apparatus for heating a passenger compartment of a vehicle having an engine room defining a ram airflow path and an engine located in the engine room is provided. The vehicle includes a sensor configured to detect one or more operating conditions of the vehicle. A heater is configured to provide heated air to the passenger compartment, and the heater thermally is coupled to the engine. A cooling pack in the ram airflow path is thermally coupled to the engine, and the cooling pack includes at least one of a radiator and a condenser. A fan is positioned in the ram airflow path adjacent the cooling pack, and the fan is responsive to a control signal to operate in a forward direction in which the fan moves air in a direction of the ram airflow path, and a reverse direction in which the fan moves air in an opposite direction of the ram airflow path. A controller is responsive to the sensor and configured to generate the control signal to operate the fan in the forward direction when the detected one or more operating conditions are in a first state and to operate the fan in the reverse direction when the detected one or more operating conditions are in a second state.

In another embodiment, a method for heating the passenger compartment of a vehicle having an engine room defining a ram airflow path, a fan located in the ram airflow path, an engine, and a heater configured to heat the passenger compartment using waste heat of the engine is provided. The method includes detecting one or more operating conditions of the vehicle including at least one of a passenger compartment heat demand and a heater heat capacity, driving the fan in a forward direction when the detected operating conditions are in a first state, and driving the fan in a reverse direction when the detected operating conditions are in a second state.

### BRIEF DESCRIPTION OF THE DRAWINGS

The description herein makes reference to the accompanying drawings wherein like reference numerals refer to like parts throughout the several views, and wherein:

FIG. 1 is a partially exploded perspective view of a vehicle and a reversible fan;

FIG. 2 is a schematic diagram of an engine room;

FIG. 3 is a flowchart of communication between a sensor, a controller, and a fan; and

FIG. 4 is a flowchart of a logic of the of FIG. 3 controller.

### DETAILED DESCRIPTION

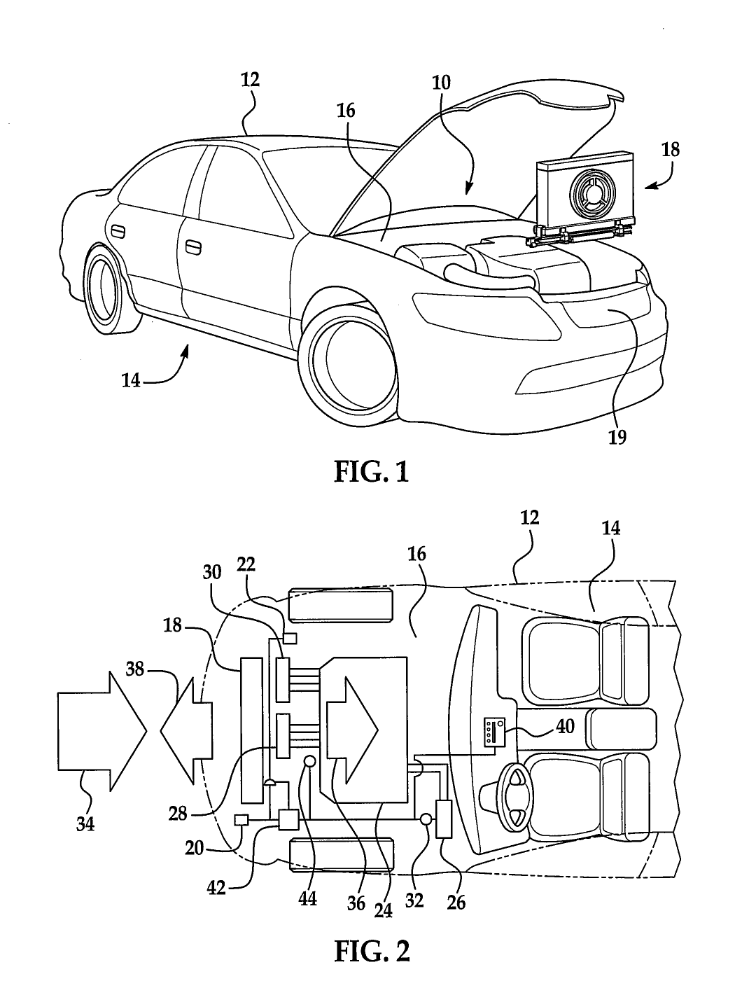

FIGS. 1-4 illustrate a heat exchanging system according to the present invention.

FIG. 1 illustrates a heating system 10 in a vehicle 12. While the illustrated vehicle 12 is a sedan, the heating system 10 can also be used in trucks, buses, sports cars, and other types of vehicles. The heating system 10 provides warm air to a passenger compartment 14. The system 10 includes components located in an engine room 16 of the vehicle. While the illustrated engine room 16 is located underneath a hood of the vehicle 12, the engine room can be located at another location, e.g., beneath a passenger compartment.

As illustrated in FIGS. 1 and 2, the engine room 16 includes a fan 18. The fan 18 can be positioned directly inside a grille 19 of the vehicle 12. Alternatively, the fan 18 can be positioned at another location in the engine room 16, such as spaced from the grille 19 with a cooling pack between the fan 18 and the grille 19, or at another location in fluid communication with the engine room 16. The fan 18 can be an electric fan powered by a vehicle battery or another power source. The fan 18 can be a variable speed fan capable of producing a continuous range of airflow speeds, or the fan can produce only a certain number of airflow speeds, e.g., two or three speeds. Additionally, the fan 18 can be rotatable in two directions to produce airflow in two opposing directions, i.e., airflow in a direction toward a rear of the vehicle 12 (i.e., a normal airflow path 36) and airflow toward a front of the vehicle 12 (i.e., a reverse airflow path 38). The fan 18 can include, for example, a brushless motor controlled by pulse width modulation (PWM).

As further illustrated in FIG. 2, an ambient air sensor 20 is located on the vehicle 12 outside the engine room 16. The sensor 20 can be positioned at a suitable location for measuring an ambient air temperature external the vehicle 12, such as on a bumper of the vehicle 12, underneath the vehicle 12, or elsewhere on the vehicle 12. The air sensor 20 can be located internally, e.g., inside the engine room 16, so long as the sensor 20 is able to obtain a substantially accurate ambient air temperature measurement.

Also as illustrated in FIG. 2, an engine room temperature sensor 22 is positioned in the engine room 16. Alternatively, the engine room temperature sensor 22 can be positioned at another location in which the sensor 22 can obtain a measurement of a temperature indicative of the temperature of the heat exchanging system 10. For example, the sensor 22 can be positioned in a conduit between the engine compartment 16 and the passenger compartment 14 in order to obtain an indirect measurement of the engine room 16 temperature. Moreover, the temperature of the engine room 16 may vary depending on the exact location in which a measurement is taken, and the position of the sensor 22 should be taken into consideration in operating the system 10. For example, positioning the sensor 22 close to an engine 24 can result in a higher temperature reading than positioning the sensor 22 away from the engine 24, and the heat exchanging system 10 should be controlled accordingly as is described in greater detail below.

FIG. 2 also illustrates the engine 24 in the engine room 16. The engine 24 can be a gasoline internal combustion engine, a diesel internal combustion engine, an electric motor, a hydrogen fuel cell, or another device that produces heat during operation.

FIG. 2 additionally illustrates a cooling pack and a heater 26 in thermal communication with the engine 24. The cooling pack can include a radiator 28, a condenser 30, and/or other heat exchangers for transferring heat from engine coolant, engine oil, transmission oil, and/or other fluids to an ambient environment. The cooling pack can include discrete heat exchangers, e.g., a separate radiator 28 and condenser 30, or the cooling pack can be an integral unit including a radiator, condenser, and additional heat exchangers. Moreover, the cooling pack can include just one heat exchanger, e.g., only one of the condenser 28 and the radiator 30. The cooling pack is positioned in a ram airflow path 34, such as at a location on the opposing side of the fan 18 from the grille 19 as shown, or between the fan 18 and the grille 19.

The ram airflow path 34 is a path for air entering the engine room 16 while the vehicle 12 is traveling. For example, the ram airflow path 34 can include a path through the grille 19 or another air inlet positioned to receive air as the vehicle 12 travels. The ram airflow path 34 extends into the engine room 16, and the exact geometry of the path 34 depends on the size and location of the grille 19 and/or other air inlets, the cooling pack, the engine 24, and other vehicle 12 parts in the engine room 16. The ram airflow path 34 need not be a single, continuous line; the path 34 can include branches and junctions where air streams diverge and converge, respectively. The ram airflow path 34 is generated during forward travel of the vehicle 12, and therefore the path 34 is generally aligned with the normal fan airflow 36 and opposed by the reverse fan airflow 38.

The heater 26 is a heat exchanger, e.g., a radiator, in thermal communication with the engine 24 and the passenger compartment 14. A fan can produce an airflow for forcing convective heat transfer from the heater 26 to the passenger compartment 14 through a series of ducts. A thermostat can be included within at least one of the ducts to regulate the operation of the heater 26, for example, by opening to allow heated air to flow from the heater 26 to the passenger compartment 14 or closing to prevent heated air to flow. While the heater 26 is illustrated in the engine room 16, the heater 26 can alternatively be positioned at another location, e.g., between the engine room 16 and passenger compartment 14.

A heater temperature sensor 32 can be used to measure the temperature of the heater 26. The heater temperature sensor 32 can be positioned to contact the heater 26 or at another location in which the sensor 32 can obtain a measurement of a temperature indicative of the temperature of the heater 26, such as in an airflow from the heater 26 to the passenger compartment 14.

Also as illustrated in FIG. 2, the passenger compartment 14 includes a heater control 40. The heater control 40 is a control for generating a heat demand signal, which can include a demand to heat the passenger compartment 14 to a specific objective (e.g., 72° F.) or subjective (e.g., “Low”, “Medium”, or “High”) temperature. In addition or alternative to the heater control 40, the heat demand signal be produced in consideration of the ambient air temperature as measured by the ambient air temperature sensor 20 or another temperature, e.g., the temperature of the engine room 16, engine 24, or heater 26, as is discussed below in greater detail.

A controller 42, as shown in FIG. 2, is in communication with the ambient air temperature sensor 20, the engine room temperature sensor 22, the heater temperature sensor 32, the heater control 40, and an engine temperature sensor 44 positioned to measure the temperature of the engine 24. The controller 42 generally includes a CPU, a memory and other peripheral circuits. Note that sensors 20, 22, 32, and 44 and heater control 40 are not all necessary. The controller 42 can operate from the input of a single sensor, e.g., the heater sensor 32, if desired. However, more accurate control may be obtainable with the use of multiple sensors. While the controller 42 is illustrated as being positioned in the engine room 16, the controller 42 can be located elsewhere in the vehicle 12.

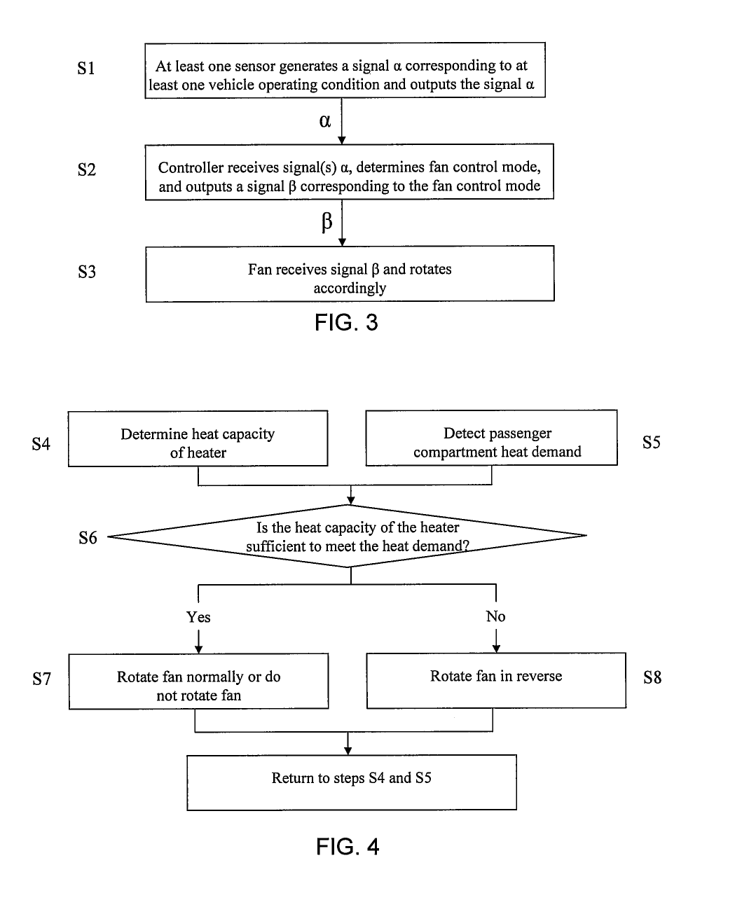

Operation of the heat exchanging system 10 is shown in FIGS. 3 and 4. As shown in step S1 of FIG. 3, one or more of the sensors 20, 22, 32, 44 and the heater control 40 can generate respective signals α and transmit the signals α to the controller 42. Additional sensors can detect other vehicle operating conditions, such as the speed and/or acceleration of the vehicle 12, a rotational speed of the engine 24, a time the engine 24 has been operating, or a signal corresponding to airflow into the engine room 16, and output of the additional sensors can also be included in the signals α. As shown in step S2, the controller 42 receives the signal(s) α, determines the proper control mode of the fan 18, and outputs a signal β corresponding to the fan control mode. The logic employed by the controller 42 will be discussed later in reference to FIG. 4. Referring still to FIG. 3, in step S3 the fan 18 receives the signal β output by the controller 42 and rotates accordingly.

FIG. 4 illustrates the logic employed by the controller 42 in controlling the fan 18. In step S4, the controller 42 determines a heat capacity of the heater 16. The heat capacity of the heater 16 can be based on the signal output by the heater sensor 32 corresponding to the temperature of the heater 16. That is, the hotter the heater 16, the greater the heat capacity of the heater 16. Additionally, since the heater 16 is in thermal communication with the engine 24, the controller 42 can determine the heat capacity based on another temperature, e.g., the temperature of the engine 24 or the temperature of the engine room 16. Alternatively, the heater capacity can be estimated based on one or more of the ambient temperature, the rotational speed of the engine 24, the speed of the vehicle 12, and the time the engine 24 has been operating.

In step S5 of FIG. 4, the controller 42 determines the passenger compartment heat demand. As described above, the heat demand can be a function of the heater control 40 setting. In addition or alternative to the heater control 40, the heat demand signal be produced in consideration of the ambient air temperature as measured by the ambient air temperature sensor 20 or another temperature, e.g., the temperature of the engine room 16, engine 24, or heater 26, into consideration. For example, the controller 42 can determine that the heat demand is high when the ambient temperature is low. Additionally, since there is a relationship between the ambient air temperature and the engine room 16, engine 24, and heater 26 temperatures, the controller 42 can take these temperatures into consideration. As an example of the controller 42 taking multiple settings into consideration, the controller 42 can be configured to calculate a heat demand based on vehicle operating conditions excluding the heater control 40 setting and to control the fan 18 on the basis of a heat demand calculated from measured temperatures, unless the calculated heat demand is lower than the setting of the heater control 40.

As shown in step S6 of FIG. 5, the controller 42 determines whether the heater 16 can provide sufficient heat to the passenger compartment 14 to meet the heat demand. The determination can include a calculation including only the heat demand (e.g., whether the heat demand is greater than a predetermined value), a calculation including the heat demand and the heat capacity (e.g., whether the heat demand is greater than the heat capacity, or whether the heat demand is greater than the heat capacity plus a threshold value), or a calculation including the heat demand and at least one of the operating conditions. The predetermined value and threshold value can be determined experimentally or calculated based on the design of the heat exchanging system 10 and vehicle 12.

If the heat capacity is sufficient to heat the passenger compartment 14, the controller rotates the fan 18 to produce normal fan airflow 36 as shown in step S7. Depending on the fan 18, the normal fan airflow 36 speed can be varied continuously or as a step function, e.g., between two discrete speeds. Additionally, the controller 42 can stop rotation of the fan 18 in step S7, for example, if the engine 24 is adequately cooled without the normal fan airflow 36 provided by the fan 18. However, if the heat capacity is insufficient to heat the passenger compartment, the controller rotates the fan 18 to produce reverse fan airflow 38 as shown in step S8 of FIG. 5

Reverse fan airflow 38 is airflow in a direction opposing the direction of ram airflow 34 as described above. Reverse fan airflow 38 can cancel out at least a portion of the ram airflow 34, thereby reducing the forced convection of heat away from the cooling pack when the vehicle 12 is travelling. As a result, the cooling pack transfers less heat from the engine 24 to the ambient environment, causing the engine 24 to heat faster. As the heat of the engine 24 increases, the amount of heat transferred from the engine 24 to the heater 26 increases. Thus, rotating the fan 18 to produce reverse fan airflow 38 increases the heat capacity of the heater 26.

Additionally, reverse fan airflow 38 can also be beneficial when the vehicle 12 is idle. For example, if the ambient temperature is greater than the engine room temperature, reverse fan airflow 38 can draw relatively warmer air over the cooling pack to increase the engine temperature. Regardless of the vehicle 12 speed, operation of the fan 18 increases the load on the engine 24 and as a result increases the rate at which the engine 24 produces heat. Reverse fan airflow 38 can continue for a predetermined time, or the controller 42 can determine the rotational velocity of the fan 18 at predetermined intervals.

As described above, by monitoring the operating conditions of a vehicle and controlling a fan positioned adjacent a cooling pack accordingly, the heat capacity of a heater can be increased. An increased heat capacity enables the heater to more quickly meet a heat demand of a passenger compartment. Thus, the passenger compartment can be warmed to a comfortable temperature more quickly than without a reversible fan. Additionally, the system allows more accurate control of the fan when the fan is rotating in a normal direction.

Conventional grille covers should be installed or removed according to ambient air temperature fluctuations, which can be frequent during transitional times between seasons or when driving a long distance. Moreover, a conventional grille cover may be desirable when an engine initially starts, but after running for a period of time the engine may heat up to the point that a grille cover is no longer necessary. The system as described above can react to changing conditions, eliminating the need for a grille cover and its associated disadvantages.

While the invention has been described in connection with what is presently considered to be the most practical embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for heating a passenger compartment of a vehicle, the vehicle having an engine room defining a ram airflow path, an engine located in the engine room, and a cooling pack located in the ram airflow path for dissipating waste heat generated by the engine, the apparatus comprising:
a heater configured to provide heated air to the passenger compartment, the heater in thermal communication with the engine to transfer waste heat from the engine to the passenger compartment;
a sensor configured to detect one or more operating conditions of the vehicle;
a fan positioned in the ram airflow path, the fan responsive to a control signal to operate in at least two modes relative to the ram airflow path; and
a controller responsive to the sensor and configured to generate the control signal to operate the fan in a first mode when the detected one or more operating conditions are in a first state and to operate the fan in a second mode when the detected one or more operating conditions are in a second state.

2. The apparatus of claim 1, wherein the first mode is the operation of the fan at a first speed and the second mode is the operation of the fan at a second speed.

3. The apparatus of claim 2, wherein the operating conditions include a passenger compartment heat demand and a heater heat capacity;
wherein the first state includes the heat capacity being greater than the heat demand by a threshold value; and
wherein the first speed is greater than the second speed.

4. The apparatus of claim 1, wherein the first mode is the operation of the fan in a forward direction in which the fan moves air in a direction of the ram airflow path, and the second mode is the operation of the fan in a reverse direction in which the fan moves air in an opposite direction of the ram airflow path.

5. The apparatus of claim 4, wherein the one or more operating conditions of the vehicle include a detected temperature of at least one of ambient air, the engine room, the heater, and the engine; and
wherein the first state includes the detected temperature being greater than a threshold temperature and the second state includes the detected temperature being less than or equal to the threshold temperature.

6. The apparatus of claim 5, wherein the threshold temperature is a predetermined constant.

7. The apparatus of claim 5, wherein the operating conditions include a passenger compartment heat demand; and
wherein the threshold temperature is computed based on heat demand.

8. The apparatus of claim 1, wherein the operating conditions include a heater heat capacity; and
wherein the first state includes the beat capacity being less than a threshold value.

9. The apparatus of claim 8, wherein the operating conditions further include a passenger compartment heat demand; and
wherein the threshold value is computed based on heat demand.

10. The apparatus of claim 4, wherein the fan is responsive to the control signal to operate at a plurality of speeds in at least one of the forward direction and reverse direction; and
wherein the controller is further configured to generate the control signal to operate the fan at a selected one of the plurality of speeds based on the detected operating conditions.

11. The apparatus of claim 1, wherein the operating conditions include a heater heat capacity and a passenger compartment heat demand; and
wherein the first state includes heat capacity being greater than heat demand by a threshold value, and the second state includes heat capacity being less than or equal to heat demand by the threshold value.

12. The apparatus of claim 11, wherein the threshold value is zero or greater.

13. The apparatus of claim 4, wherein the fan is positioned adjacent the cooling pack to reduce ram airflow over the cooling pack when the fan operates in the reverse direction.

14. An apparatus for heating a passenger compartment of a vehicle, the vehicle having an engine room defining a ram airflow path and an engine located in the engine room, the apparatus comprising:
a sensor configured to detect one or more operating conditions of the vehicle;
a heater configured to provide heated air to the passenger compartment, the heater thermally coupled to the engine;
a cooling pack in the ram airflow path and thermally coupled to the engine, the cooling pack including at least one of a radiator and a condenser;
a fan positioned in the ram airflow path adjacent the cooling pack, the fan responsive to a control signal to operate in a forward direction in which the fan moves air in a direction of the ram airflow path, and a reverse direction in which the fan moves air in an opposite direction of the ram airflow path; and
a controller responsive to the sensor and configured to generate the control signal to operate the fan in the forward direction when the detected one or more operating conditions are in a first state, and to operate the fan in the reverse direction when the detected one or more operating conditions are in a second state.

15. The apparatus of claim 14, wherein the operating conditions include a detected temperature of at least one of ambient air, the engine room, the heater and the engine.

16. The apparatus of claim 15, wherein the first state includes the detected temperature being greater than a threshold temperature and the second state includes the detected temperature being less than or equal to the threshold temperature.

17. The apparatus of claim 14, wherein the operating conditions include a heater heat capacity; and
wherein the first state includes the heat capacity being less than a threshold value.

18. The apparatus of claim 17, wherein the threshold value is a predetermined constant.

19. The apparatus of claim 17, wherein the operating conditions further include a passenger compartment heat demand; and
wherein the threshold value is computed based on the heat demand.

20. The apparatus of claim 14, wherein the operating conditions include a heater heat capacity and a passenger compartment heat demand;
wherein the first state includes the heat capacity being greater than the heat demand; and
wherein the second state includes the heat capacity being less than or equal to the heat demand.

21. A method for heating the passenger compartment of a vehicle having an engine room defining a ram airflow path, a fan located in the ram airflow path, an engine, and a heater configured to heat the passenger compartment using waste heat of the engine, the method comprising:
detecting one or more operating conditions of the vehicle including at least one of a passenger compartment heat demand and a heater heat capacity;
driving the fan in a forward direction when the detected operating conditions are in a first state;
driving the fan in a reverse direction when the detected operating conditions are in a second state.

22. The method of claim 21, wherein the first state includes the heat capacity being greater than the heat demand by a threshold value that is zero or greater.

23. The method of claim 21, further comprising:
turning the fan off when the detected operating conditions are in a third state.

24. The method of claim 21, further comprising:
driving the fan in a forward direction after the detected operating conditions have been in the second state for a predetermined amount of time.

25. The method of claim 21, further comprising varying a rotational speed of the fan based on the detected operating conditions.
